(19) United States
(12) Patent Application Publication
(10) Pub. No.: US 2018/0297345 A1
(43) Pub. Date: Oct. 18, 2018

(54) LAMINATION TECHNIQUE FOR PRODUCING ELECTRONIC DEVICES

(71) Applicant: FLEXENABLE LIMITED, Cambridge (GB)

(72) Inventors: Barry WILD, Peterborough (GB); William Henry REEVES, Cambrigde (GB)

(73) Assignee: FLEXENABLE LIMITED, Cambridge (GB)

(21) Appl. No.: 15/766,410

(22) PCT Filed: Oct. 6, 2016
(86) PCT No.: PCT/EP2016/073918

§ 371 Date: Apr. 6, 2018

(30) Foreign Application Priority Data
Oct. 9, 2015 (GB) 1517923.7

(51) Int. Cl. B32B 37/00; B32B 37/10

(52) U.S. Cl. CPC B32B 37/0015; B32B 2310/0831; B32B 37/10

(57) ABSTRACT

A method for producing electronic devices or components therefor comprising providing first and second components for laminating together the first and second components to define active areas. Then, applying adhesive to the first and/or second components, and successively laminating increasingly distal portions of said second component to the first component in a lamination direction. At least a part of the adhesive applied to the first and/or second components in an area downstream of active areas in the lamination direction defines an array of pairs of line sections of adhesive, each pair of line sections converging to a respective meeting point in a direction opposite to said lamination direction. The array of pairs of line sections extends continuously across substantially the whole lateral width of said one or more active areas, without any spaces or lateral line sections between each pair of lines sections in the array.

Laminating two components together can be an important process in the production of electronic devices.

The inventors for the present application have worked on a laminating technique for producing electronic devices involving successively laminating increasingly distal portions of a thin, flexible component to another component. As discussed in more detail below, the inventors have identified the problem of crinkling appearing in the thin, flexible component during the lamination process and have developed techniques to better prevent such crinkling.

There is hereby provided a method of producing at least one electronic device or at least one component for an electronic device, the method comprising: providing first and second components for laminating together at least one of the first and second components defining one or more active areas; applying adhesive to at least one of the first and second components; and successively laminating increasingly distal portions of said second component to said first component in a lamination direction; wherein at least a part of said adhesive applied to said first and/or second components in an area downstream of all one or more active areas in the lamination direction defines an array of pairs of line sections of adhesive, each pair of line sections converging to a respective meeting point in a direction opposite to said lamination direction; wherein said array of pairs of line sections extends continuously across substantially the whole lateral width of said one or more active areas, without any spaces or lateral line sections between each pair of lines sections in the array.

There is hereby provided a method of producing at least one electronic device or at least one component for an electronic device, the method comprising: providing first and second components for laminating together, at least one of the first and second components defining one or more active areas; applying adhesive to at least one of the first and second components; and successively laminating increasingly distal portions of said second component to said first component in a lamination direction; wherein at least a part of said adhesive applied to said first and/or second components defines an array of pairs of line sections of adhesive, each pair of line sections converging to a respective meeting point in a direction opposite to said lamination direction; wherein the laminating comprises using a roller to successively force increasingly distal portions of the second component against the first component whilst maintaining the part of the second component upstream of the roller under tension, and releasing the force of the roller against the second component when the roller is in contact with a finish portion of the second component, and wherein said array of pairs of line sections is defined by the applied adhesive in at least said finish portion and/or at least in a portion between said finish portion and the most distal active area of said one or more active areas.

There is hereby provided a method of producing at least one electronic device or at least one component for an electronic device, the method comprising: providing first and second components for laminating together; applying adhesive to at least one of the first and second components; and successively laminating increasingly distal portions of said second component to said first component in a lamination direction; wherein at least a part of said adhesive applied to said first and/or second components defines an array of pairs of line sections of adhesive, each pair of line sections converging to a respective meeting point in a direction opposite to said lamination direction.

According to one embodiment, said pairs of line sections are joined to each other at distal ends of said pairs.

According to one embodiment, said array of pairs of line sections defines at least one continuous zig-zag line extending in a direction substantially perpendicular to said lamination direction.

According to one embodiment, said array of pairs of line sections is defined by at least a most distal portion of the applied adhesive in the lamination direction.

According to one embodiment, the laminating comprises using a roller to successively force increasingly distal portions of the second component against the first component whilst maintaining the part of the second component upstream of the roller under tension, and curing said most distal portion of the applied adhesive before releasing the force of the roller against the second component.

According to one embodiment, the laminating comprises using a roller to successively force increasingly distal portions of the second component against the first component whilst maintaining the part of the second component upstream of the roller under tension, and releasing the force of the roller against the second component when the roller is in contact with a finish portion of the second component, and wherein said array of pairs of line sections is defined by the applied adhesive in at least said finish portion and/or at least in a portion between said finish portion and the most distal active area of said one or more active areas.

According to one embodiment, said array of pairs of line sections is defined by the applied adhesive in at least a portion immediately upstream of the finish portion.

According to one embodiment, the method further comprises curing said adhesive in at least said finish portion and/or in at least said portion between said finish portion and the most distal active area before releasing the force of the roller against the second component.

According to one embodiment, the first and second components contain therebetween in said one or more active areas a liquid material having one or more properties controllable by electrical circuitry of the first and second components, or a liquid material in which chemical and/or physical changes are detectable by electrical circuitry of the first and second components.

According to one embodiment, the one or more active areas comprise one or more display area regions for one or more liquid crystal display devices, and said first and second components contain a liquid crystal material therebetween in the one or more display area regions.

According to one embodiment, the one or more active areas comprise one or more sensing areas for one or more sensor devices, and the first and second components contain an electrochemically reactive liquid material in the one or more sensing areas.

There is hereby provided a method of producing an electronic device or a component for an electronic device, the method comprising: providing first and second components for laminating together; applying adhesive to at least one of the first and second components; and laminating said second component to said first component; wherein the laminating comprises using a roller to successively force increasingly distal portions of the second component against the first component whilst maintaining the part of the second component upstream of the roller under tension; and curing at least a most distal part of the applied adhesive before releasing the force of the roller against the second component.

According to one embodiment, said most distal portion of the applied adhesive is located at the line of contact of the second component with the roller when releasing the force of the roller against the second component, or is located between the most distal active area and said line of contact of the second component with the roller when releasing the force of the roller against the second component.

According to one embodiment, said most distal portion is located immediately upstream of the line of contact of the second component with the roller when releasing the force of the roller against the second component.

According to one embodiment, the first and second components contain therebetween a liquid material having one or more properties controllable by electrical circuitry of the electronic device, or a liquid material in which chemical and/or physical changes are detectable by electrical circuitry of the electronic device.

According to one embodiment, the first and second components contain a liquid crystal material therebetween in at least one display area region for at least one liquid crystal display device.

According to one embodiment, the first and second components contain an electrochemically reactive liquid material in at least one sensing area for at least one sensor device.

Embodiments of the invention are described in detail hereunder, by way of example only, with reference to the accompanying drawings, in which:

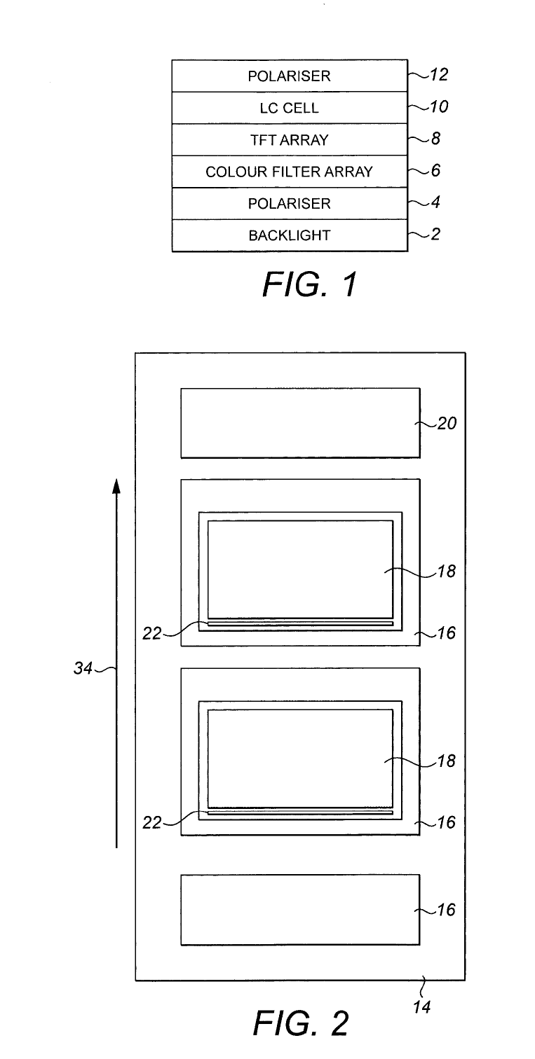

FIG. 1 illustrates one example of a liquid crystal display device;

FIG. 2 illustrates one example of where to dispense adhesive and liquid crystal material on a base component in relation to one or more active display areas;

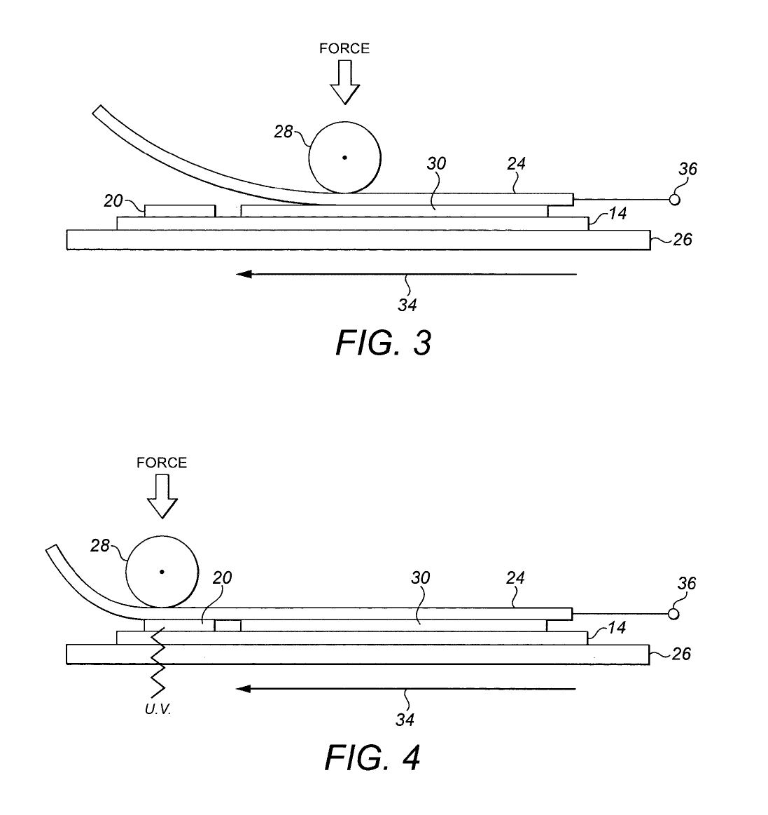

FIGS. 3 and 4 illustrate one example of a process of laminating a flexible upper component to a base component;

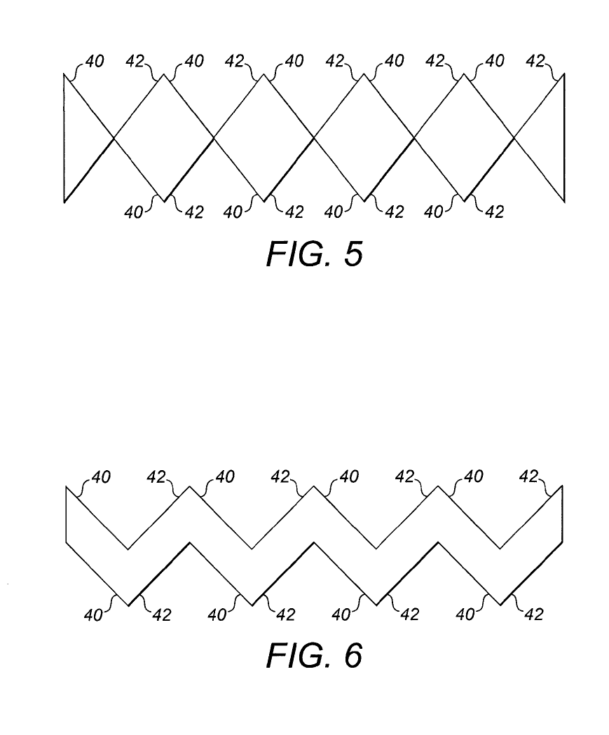

FIGS. 5 and 6 illustrate examples of adhesive patterns;

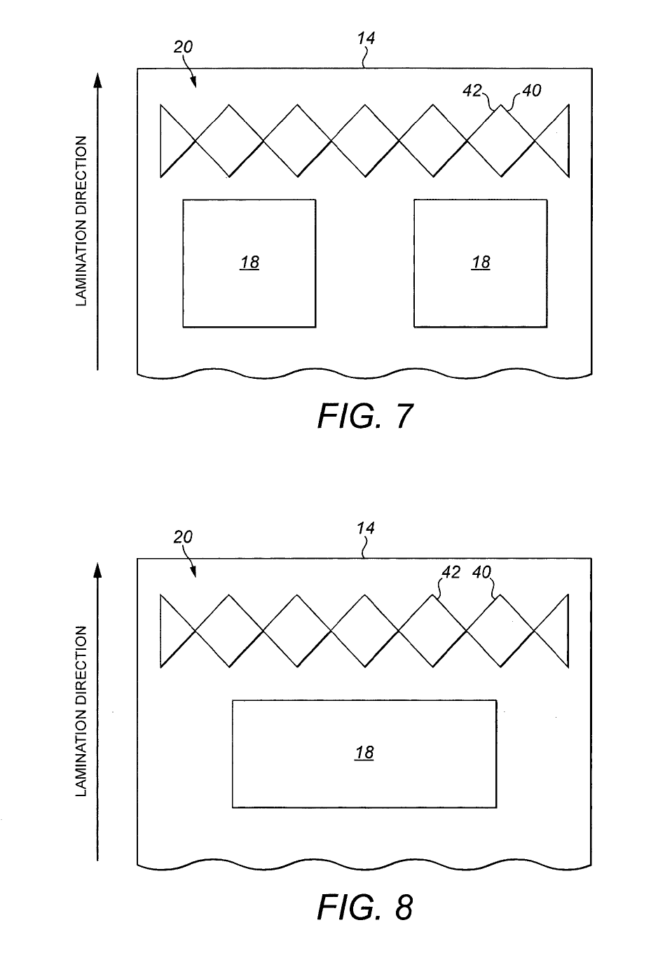

FIG. 7 shows the arrangement of the adhesive patterns of FIGS. 5 and 6 in relation to the active areas for one example of an array of active areas; and

FIG. 8 shows the arrangement of the adhesive patterns of FIGS. 5 and 6 in relation to another example of an array of active areas.

A detailed description of techniques according to embodiments of the invention is provided below for the example of producing a liquid crystal display (LCD) device, but the same techniques are also useful in the production of other types of electronic devices including liquid functional materials, as discussed below.

FIG. 1 illustrates one example of a transmissive-type LCD device, but the techniques described below are also equally applicable to reflective-type LCD devices.

A transmissive-type LCD device comprises a liquid crystal cell 10 between two polarisers 4, 12.

The transmissive-type LCD device also comprises electrical circuitry 8 to independently control the electric potential at each of an array of pixel conductors and thereby independently vary an electric field in the liquid crystal material of the liquid crystal cell 10 for each pixel, and thereby independently control one or more optical properties of the liquid crystal material for each pixel. The electrical circuitry may comprise an array of thin film transistors (TFTs), including one or more TFTs for each pixel, and addressing conductors for independently addressing the source and gate electrodes of one or more of the TFT(s) for each pixel from one or more driver chips outside one or more edges of the active display area. For the example of an in-plane switching (IPS) device, the electrical circuitry also comprises a common conductor on the same side of the liquid crystal material as the pixel conductors. The technique described below is also applicable to other kinds of liquid crystal devices in which the common conductor is provided on the opposite side of the liquid material to the pixel conductors.

The transmissive-type LCD device also comprises a white backlight 2 and a colour filter array 6 to enable a full colour display device. A transmissive-type LCD device may comprise additional components, and/or the order of the components may be different to that shown in FIG. 1.

FIGS. 2 to 4 illustrate a lamination technique for the example of producing in a single lamination process the liquid crystal cells of two LCD devices, but the techniques described below can also be used when producing a single liquid crystal cell for a single LCD device in a single lamination process, or producing more than two liquid crystal cells for more than two LCD devices in a single lamination process.

The lamination technique involves laminating a flexible upper component 24 to a base component 14, onto which adhesive 16, 20 and liquid crystal material 22 has been pre-dispensed in the areas shown in FIG. 2. As discussed below, in at least adhesive area 20, adhesive is deposited as a continuous line defining an array of pairs of line sections 40, 42, each pair of line sections converging to a respective meeting point in a direction opposite to the lamination direction 34.

The liquid crystal material 22 for each liquid crystal cell is dispensed in the form a line 22 parallel to, but slightly spaced apart from, the upstream/proximal edge of the active display area 18.

The adhesive 16, 20 is provided to prevent delamination during cell assembly and later processing/use and/or to contain the liquid crystal material.

Although not shown in the drawings, spacer structures are also provided on at least one of the base and upper components to maintain a separation distance between the base component 14 and the upper component 24 in the active display areas 18. The spacer structures 32 may, for example, form an integral part of the base component 14. For example, they may be formed by photolithographically patterning an upper insulator layer of the base component 14.

The base component 14 may also be a flexible component and supported on a relatively rigid carrier 26 during the lamination process. The base component 14 may, for example, include a flexible plastic support film supporting a colour filter array and a stack of patterned conductor, semiconductor and insulator layers to define an array of TFTs, pixel conductors and addressing conductors for addressing the TFTs from one or more driver chips outside the active display area 18. The upper component 24 may be dimensioned or shaped such that it can be laminated to the base component 14 without covering the terminals of the addressing circuitry outside the active display area, which terminals are, for example, for connection to the terminals of one or more driver chips to be bonded directly to the base component 14. For example, the upper component 24 may have a width (dimension perpendicular to the lamination direction) less than that of the base component 14, across the whole length of the upper component.

The flexible upper component 24 may also comprise a polariser 12 and/or other components of the LCD device, such as a common conductor (COM) for some types of LCD devices.

The base and upper components 14, 24 also comprise alignment coatings (not shown) adjacent to the liquid crystal material in the active display areas 18 in the finished liquid crystal cell(s), which alignment coatings influence the orientation of the molecules of the liquid crystal material.

The lamination process involves using a roller 28 to successively force increasingly distal portions of the flexible upper component 24 against the base component 14, whilst a proximal end of the flexible upper component 24 is secured to a fixed point 36 to hold the portion of the flexible upper component 24 upstream of the roller (i.e. the portion of the upper component 24 between the roller 28 and the fixed point 36) in tension. The lamination process continues until the roller 28 is located over (or beyond) the most distal portion 20 of the adhesive.

In FIGS. 3 and 4, the element labelled 30 collectively indicates the adhesive 16 and liquid crystal material 22 dispensed onto the base component, other than the adhesive dispensed in adhesive area 20. During the lamination process, the line of liquid crystal material 22 for a LCD device becomes spread over the whole of the active display area 18 for that LCD device.

As mentioned above, the lamination process continues until the roller 28 is located over (or beyond) the most distal portion 20 of the adhesive. The adhesive dispensed in this area 20 comprises a continuous line that defines an array of pairs of line sections (40, 42), each pair converging to a meeting point in a direction opposite to the lamination direction. Two examples are shown in FIGS. 5 and 6. In the example of FIG. 5, the continuous line of adhesive comprises two intersecting zig-zag lines each extending in a direction substantially perpendicular to the lamination direction. In the example of FIG. 6, the continuous line of adhesive comprises two parallel, non-intersecting zig-zag lines each extending in a direction substantially perpendicular to the lamination direction. As shown by the combination of FIGS. 5 and 6 with FIGS. 2 to 4, these zig-zag adhesive patterns are formed selectively in an area 20 downstream of the most downstream active areas; they are not formed anywhere else between the upper and base components. Also, as shown by the combination of FIGS. 5 and 6 with FIGS. 2 to 4 (and also by FIG. 7, which shows a distal portion of the base component 14), the area 20 over which the zig-zag patterns are formed extends across the whole width of the active areas 18. The zigzag patterns provide a continuous and unbroken set of diagonal line sections extending (in area 20) across at least the whole lateral width of the one or more active areas 18 (and in one example, across substantially the whole width of the base/upper component to which the adhesive is applied), without any spaces or lateral line sections between the diagonal line sections. The lateral width refers to the width in a direction perpendicular to the lamination direction. If two or more active areas 18 are arranged in series across the lateral width of the base/upper component to which the adhesive is applied in area 20, the zigzag patterns provide a continuous and unbroken set of diagonal line sections extending (in area 20) at least between the respective outer edges of the pair of outermost active areas 18, without any spaces or lateral line sections between the diagonal line sections, as shown in FIG. 8, which shows a distal portion of the base component 14. Each diagonal line section 40, 42 leads directly into another diagonal line section 40, 42, without any intervening space or lateral line section extending in a direction perpendicular to the lamination direction.

When the roller 28 reaches this most distal portion 20 of the adhesive, the adhesive in at least this most distal portion 20 is cured by ultra-violet (UV) irradiation before the force of the roller 28 against the upper component 24 is released. It may be preferable to cure adhesive in all regions simultaneously at this time, i.e. also cure the adhesive in more proximal regions 16 in addition to the adhesive in the most distal region 20. FIG. 4 shows the example of irradiation from below the base component, but the adhesive may alternatively or additionally be exposed to UV from above the upper component.

The inventors for the present application had identified a problem of crinkling appearing in the laminated portion of the upper component 24 after releasing the force of the roller 28 against the upper component 24; and have found that such crinkling can be better prevented by the techniques described above. Without wishing to be bound by theory, it is thought that adhesive patterns of the kind shown in FIGS. 5 and 6 are effective because they act to better prevent crinkling in the excess portion of the upper component 24 downstream of the roller 28 (which excess portion is never under tension) propagating beyond the distal adhesive portion 20 when releasing the force of the roller 28 against the upper component 24.

The inventors for the present application have found that these techniques are particularly effective for reducing crinkling when using plastic films having a thickness of about 40 microns and less for the upper component; crinkling can be less of a problem when using plastic films having a thickness of about 60 microns and greater. Reducing the thickness of the base and upper components can be beneficial for producing a flexible device; thinner films are found to generally generate less stress within the laminated composite upon bending the composite.

As mentioned above, the techniques described above are also useful for the production of electronic devices other than liquid crystal display devices. For example, the techniques described above are also useful for the production of other types of electronic devices that contain a liquid functional material between two components, such as an electronic gas sensor device containing an electrochemically reactive liquid material that chemically reacts with a gas to be sensed, which chemical reaction can be detected by electrical circuitry of the device.

In addition to any modifications explicitly mentioned above, it will be evident to a person skilled in the art that various other modifications of the described embodiments may be made within the scope of the invention.

1. A method of producing at least one electronic device or at least one component for an electronic device, the method comprising: providing first and second components for laminating together at least one of the first and second components defining one or more active areas; applying adhesive to at least one of the first and second components; and successively laminating increasingly distal portions of said second component to said first component in a lamination direction; wherein at least a part of said adhesive applied to said first and/or second components in an area downstream of all one or more active areas in the lamination direction defines an array of pairs of line sections of adhesive, each pair of line sections converging to a respective meeting point in a direction opposite to said lamination direction; wherein said array of pairs of line sections extends continuously across substantially the whole lateral width of said one or more active areas, without any spaces or lateral line sections between each pair of lines sections in the array.

2. A method of producing at least one electronic device or at least one component for an electronic device, the method comprising: providing first and second components for laminating together, at least one of the first and second components defining one or more active areas; applying adhesive to at least one of the first and second components; and successively laminating increasingly distal portions of said second component to said first component in a lamination direction; wherein at least a part of said adhesive applied to said first and/or second components defines an array of pairs of line sections of adhesive, each pair of line sections converging to a respective meeting point in a direction opposite to said lamination direction; wherein the laminating comprises using a roller to successively force increasingly distal portions of the second component against the first component whilst maintaining the part of the second component upstream of the roller under tension, and releasing the force of the roller against the second component when the roller is in contact with a finish portion of the second component, and wherein said array of pairs of line sections is defined by the applied adhesive in at least said finish portion and/or at least in a portion between said finish portion and the most distal active area of said one or more active areas.

3. The method according to claim 1, wherein said pairs of line sections are joined to each other at distal ends of said pairs.

4. The method according to claim 1, wherein said array of pairs of line sections defines at least one continuous zig-zag line extending in a direction substantially perpendicular to said lamination direction.

5. The method according to claim 1, wherein said array of pairs of line sections is defined by at least a most distal portion of the applied adhesive in the lamination direction.

6. The method according to claim 5, wherein the laminating comprises using a roller to successively force increasingly distal portions of the second component against the first component whilst maintaining the part of the second component upstream of the roller under tension, and curing said most distal portion of the applied adhesive before releasing the force of the roller against the second component.

7. The method according to claim 1, wherein the laminating comprises using a roller to successively force increasingly distal portions of the second component against the first component whilst maintaining the part of the second component upstream of the roller under tension, and releasing the force of the roller against the second component when the roller is in contact with a finish portion of the second component, and wherein said array of pairs of line sections is defined by the applied adhesive in at least said finish portion and/or at least in a portion between said finish portion and the most distal active area of said one or more active areas.

8. The method according to claim 1, wherein said array of pairs of line sections is defined by the applied adhesive in at least a portion immediately upstream of the finish portion.

9. The method according to claim 1, comprising curing said adhesive in at least said finish portion and/or in at least said portion between said finish portion and the most distal active area before releasing the force of the roller against the second component.

10. The method according to claim 1, wherein the first and second components contain therebetween in said one or more active areas a liquid material having one or more properties controllable by electrical circuitry of the first and second components, or a liquid material in which chemical and/or physical changes are detectable by electrical circuitry of the first and second components.

11. The method according to claim 1, wherein the one or more active areas comprise one or more display area regions for one or more liquid crystal display devices, and said first and second components contain a liquid crystal material therebetween in the one or more display area regions.

12. The method according to claim 1, wherein the one or more active areas comprise one or more sensing areas for one or more sensor devices, and the first and second components contain an electrochemically reactive liquid material in the one or more sensing areas.

13. A method of producing an electronic device or a component for an electronic device, the method comprising: providing first and second components for laminating together;
applying adhesive to at least one of the first and second components; and laminating said second component to said first component; wherein the laminating comprises using a roller to successively force increasingly distal portions of the second component against the first component whilst maintaining the part of the second component upstream of the roller under tension; and curing at least a most distal part of the applied adhesive before releasing the force of the roller against the second component.

14. The method according to claim 13, wherein said most distal portion of the applied adhesive is located at the line of contact of the second component with the roller when releasing the force of the roller against the second component, or is located between the most distal active area and said line of contact of the second component with the roller when releasing the force of the roller against the second component.

15. The method according to claim 14, wherein said most distal portion is located immediately upstream of the line of contact of the second component with the roller when releasing the force of the roller against the second component.

16. The method according to claim 13, wherein the first and second components contain therebetween a liquid material having one or more properties controllable by electrical circuitry of the electronic device, or a liquid material in which chemical and/or physical changes are detectable by electrical circuitry of the electronic device.

17. The method according to claim 13, wherein the first and second components contain a liquid crystal material therebetween in at least one display area region for at least one liquid crystal display device.

18. The method according to claim 13, wherein the first and second components contain an electrochemically reactive liquid material in at least one sensing area for at least one sensor device.
